(19) United States
(12) Patent Application Publication
(10) Pub. No.: US 2025/0138939 A1
(43) Pub. Date: May 1, 2025

(54) DATA VALIDATION METHOD AND SYSTEM

(71) Applicant: Hangzhou AliCloud Apsara Information Technology Co., Ltd., Hangzhou (CN)

(72) Inventor: Yuewu LI, Beijing (CN)

(21) Appl. No.: 18/836,311

(22) PCT Filed: Feb. 2, 2023
(86) PCT No.: PCT/CN2023/074190

§ 371 Date: Aug. 6, 2024

(30) Foreign Application Priority Data
Feb. 14, 2022 (CN) 202210134570.4

(51) Int. Cl. G06F 11/10

(52) U.S. Cl. CPC G06F 11/1004

(57) ABSTRACT

A data validation method and a system are disclosed. At least part of first data acquired from a storage apparatus is divided into at least one data segment; calculation for each of the at least one data segment is performed to obtain at least one calculation result; for each of the at least one calculation result, data that conforms to a constraint relationship with the calculation result is searched for from the acquired first data, and a position of the data obtained through the searching in the first data is determined; a correspondence relationship between the position and the calculation result is associatively stored. Thus, when validation of the first data in the storage apparatus is performed subsequently, only the data at a specific position in the first data needs to be acquired from the storage apparatus, so efficiency of data validation may be improved.

### CROSS-REFERENCE TO RELATED APPLICATIONS

The present application is a national stage of International Application No. PCT/CN2023/074190, filed on Feb. 2, 2023, which claims priority to Chinese Patent Application No. 202210134570.4, entitled “Data Validation Method and System” and filed with the China National Intellectual Property Administration on Feb. 14, 2022. Both of the aforementioned applications are hereby incorporated by reference in their entireties.

### TECHNICAL FIELD

The present disclosure relates to the field of data protection and, in particular, to a data validation method and a system.

### BACKGROUND

In order to prevent data from being tampered with, it is necessary to validate the data to judge whether the data has been tampered with.

In existing validation solutions, all to-be-validated data (such as firmware data) needs to be read from a storage apparatus during each validation, which takes a long time. In scenarios where frequent validation is required (such as a firmware security validation scenario), the existing validation solutions cannot meet requirements for fast validation.

Therefore, a validation solution capable of improving validation efficiency is needed.

### SUMMARY

A technical problem to be solved in the present disclosure is to provide a validation solution capable of improving validation efficiency.

According to a first aspect of the present disclosure, a data validation method is provided, including: dividing at least part of first data acquired from a storage apparatus into at least one data segment; performing calculation for each of the at least one data segment to obtain at least one calculation result; for each of the at least one calculation result, searching for data that conforms to a constraint relationship with the calculation result from the acquired first data, and determining a position of the data obtained through the searching in the first data; associatively storing a correspondence relationship between the position and the calculation result.

Optionally, the method further includes: acquiring second data at the position from the storage apparatus; determining, based on the correspondence relationship, whether the acquired second data and the calculation result corresponding to the position conform to the constraint relationship; if there is second data that does not conform to the constraint relationship with the calculation result corresponding to the position, determining that the first data is tampered with.

Optionally, the step of performing the calculation for each of the at least one data segment includes: using a digest algorithm to perform the calculation for each of the at least one data segment to map the data segment of a first number of bits to data of a second number of bits, where the second number is less than the first number.

Optionally, both the data obtained through the searching and the calculation result are binary data, the data obtained through the searching and the calculation result are of a same number of bits, and the constraint relationship is: a value of any bit of the bits for the data obtained through the searching is equal to a value of a corresponding bit of the bits for the calculation result; or a value of any bit of the bits for the data obtained through the searching is not equal to a value of a corresponding bit of the bits for the calculation result; or a part of the binary data for the data obtained through the searching is equal to a corresponding part of the binary data for the calculation result, and a value of a bit of a remaining part of the binary data for the data obtained through the searching is not equal to a value of a corresponding bit of a remaining part of the binary data for the calculation result.

Optionally, the storage apparatus is a non-volatile storage apparatus, and the first data is firmware data.

Optionally, the step of the performing the calculation for each of the at least one data segment includes: using a hash algorithm to perform the calculation for each of the at least one data segment, and/or the step of the for each of the at least one calculation result, searching for data that conforms to the constraint relationship with the calculation result from the acquired first data, and determining the position of the data obtained through the searching in the first data includes: dividing the calculation result into at least one first data segment; for each of the at least one first data segment, searching for data that conforms to the constraint relationship with the first data segment from the acquired first data, and determining a position of the data obtained through the searching in the first data, the step of the associatively storing the correspondence relationship between the position and the calculation result includes: associatively storing a correspondence relationship between a data segment position and the first data segment.

According to a second aspect of the present disclosure, a data validation method is provided, including: for a position recorded in an index, acquiring second data at the position from a storage apparatus, where the index is used to record a correspondence relationship between the position and a calculation result, the calculation result is a calculation result obtained by performing calculation for a data segment, and the data segment is obtained by dividing at least part of first data stored in the storage apparatus; determining, based on the correspondence relationship, whether the acquired second data and the calculation result corresponding to the position conform to a constraint relationship; if there is second data that does not conform to the constraint relationship with the calculation result corresponding to the position, determining that the first data is tampered with.

According to a third aspect of the present disclosure, a data validation method is provided, including: acquiring first data from a storage apparatus; generating at least one piece of third data; for each of the at least one piece of third data, searching for data that conforms to a constraint relationship with the third data from the acquired first data, and determining a position of the data obtained through the searching in the first data; associatively storing a correspondence relationship between the position and the third data.

Optionally, the method further includes: acquiring second data at the position from the storage apparatus; determining, based on the correspondence relationship, whether the acquired second data and the third data corresponding to the position conform to the constraint relationship; if there is second data that does not conform to the constraint relationship with the third data corresponding to the position, determining that the first data is tampered with.

According to a fourth aspect of the present disclosure, a firmware security validation system is provided, including: a non-volatile memory, configured to store firmware data; a trusted platform control module configured to: read the firmware data from the non-volatile memory through an access bus, divide at least part of the read firmware data into at least one data segment; perform calculation for each of the at least one data segment to obtain at least one calculation result; for each of the at least one calculation result, search for data that conforms to a constraint relationship with the calculation result from the read firmware data, and determine a position of the data obtained through the searching in the firmware data; and associatively store a correspondence relationship between the position and the calculation result.

According to a fifth aspect of the present disclosure, a firmware security validation system is provided, including: a non-volatile memory and a trusted platform control module, where the trusted platform control module reads, according to a position recorded in an index, second firmware data at the position from the non-volatile memory through an access bus, where the index is used to record a correspondence relationship between the position and a calculation result, the calculation result is a calculation result obtained by performing calculation for a data segment, and the data segment is obtained by dividing at least part of first firmware data stored in the non-volatile memory; the trusted platform control module further determines, based on the correspondence relationship, whether the read second firmware data and the calculation result corresponding to the position conform to a constraint relationship, and if there is second firmware data that does not conform to the constraint relationship with the calculation result corresponding to the position, determines that the first firmware data stored in the non-volatile memory is tampered with.

According to a sixth aspect of the present disclosure, a computing device is provided, including: a processor; and a memory having executable codes stored thereon, where when the executable codes are executed by the processor, the processor is caused to execute the method according to any one of the first aspect to third aspect.

According to a seventh aspect of the present disclosure, a computer program product is provided, including: executable codes, where when the executable codes are executed by a processor of an electronic device, the processor is caused to execute the method according to any one of the first aspect to third aspect.

According to an eighth aspect of the present disclosure, a non-transitory machine readable storage medium is provided, which has executable codes stored thereon, where when the executable codes are executed by a processor of an electronic device, the processor is caused to execute the method according to any one of the first aspect to third aspect.

In the present disclosure, after at least part of first data is divided to obtain at least one data segment and calculation for each of the at least one data segment is performed to obtain at least one calculation result, for each of the at least one calculation result, data that conforms to a constraint relationship with the calculation result is searched for from the acquired first data, and a position of the data obtained through the searching in the first data is determined to indirectly store the calculation result in the first data. Thus, when validation of the first data in the storage apparatus is performed subsequently, rather than that all of the first data needs to be acquired from the storage apparatus, only the data at a specific position in the first data needs to be acquired, so efficiency of data validate may be improved.

### BRIEF DESCRIPTION OF DRAWINGS

The above and other objectives, features and advantages of the present disclosure will become more apparent by describing the exemplary embodiments of the present disclosure in more detail with reference to the accompanying drawings. In the exemplary embodiments of the present disclosure, the same reference numbers generally represent same parts.

FIG. 1 shows a schematic diagram of a principle of a data validation method of the present disclosure.

FIG. 2 shows a schematic flowchart of a data validation method according to an embodiment of the present disclosure.

FIG. 3 shows a schematic flowchart of a data validation method according to another embodiment of the present disclosure.

FIG. 4 shows a schematic structural diagram of a firmware security validation system according to an embodiment of the present disclosure.

FIG. 5 shows a mapping relationship between an encryption calculation result, an index table entry and a Firmware data area.

FIG. 6 shows a schematic flowchart of a trusted validation process of the present disclosure.

FIG. 7 shows a schematic structural diagram of a data validation apparatus according to an embodiment of the present disclosure.

FIG. 8 shows a schematic structural diagram of a data validation apparatus according to another embodiment of the present disclosure.

FIG. 9 shows a schematic structural diagram of a computing device according to an embodiment of the present disclosure.

### DESCRIPTION OF EMBODIMENTS

Preferred embodiments of the present disclosure will be described in more detail below with reference to the accompanying drawings. Although preferred embodiments of the present disclosure are shown in the drawings, it should be understood that the present disclosure may be implemented in various forms and should not be limited to the embodiments set forth herein. Instead, these embodiments are provided to make the present disclosure more thorough and complete, and the scope of the disclosure can be completely conveyed to those skilled in the art.

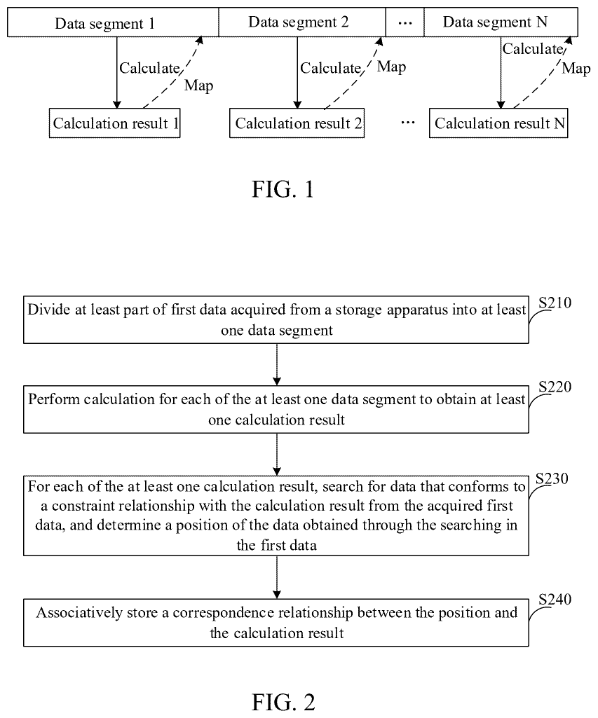

FIG. 1 shows a schematic diagram of a principle of a data validation method of the present disclosure.

As shown in FIG. 1, original data (i.e., data that has not been tampered with) is divided into N data segments first, where N is an integer greater than or equal to 1; then calculation for the N data segments are performed respectively to obtain N calculation results; finally, the N calculation results are respectively mapped to the original data to obtain mapping results of the calculation results to the original data. The mapping result of one calculation result to the original data may be a continuous data segment, or may be multiple dispersed data segments.

A rule for mapping the calculation result to the data is that the calculation result and the mapping result conform to a preset constraint relationship. The constraint relationship may refer to that the calculation result is equal to the mapping result, or that the calculation result is opposite to the mapping result.

Both the calculation result and the mapping result may refer to binary data, and a number of bits for the calculation result is the same as a number of bits for the mapping result. The calculation result being equal to the mapping result refers to that a value of any bit of the bits for the calculation result is equal to a value of a corresponding bit of the bits for the mapping result. The calculation result being opposite to the mapping result refers to that the value of any bit of the bits for the calculation result is not equal to the value of the corresponding bit of the bits for the mapping result. In addition, the constraint relationship may also refer to other relationships. For example, a part of the binary data for the calculation result is equal to a corresponding part of the binary data for the mapping result, and a value of a bit of a remaining part of the binary data for the calculation result is not equal to a value of a corresponding bit of a remaining part of the binary data for the mapping result.

After the mapping result of each calculation result to the original data is determined, a position of the mapping result in the original data (i.e., a mapping position) is also determined, which is equivalent to indirectly storing the calculation result in the original data.

When data validation is subsequently performed, if the data is tampered with, the constraint relationship between the data at the mapping position in the data that has been tampered with and the calculation result is generally destroyed. Therefore, by determining whether the data at the mapping position and the calculation result still conform to the constraint relationship, it can be determined whether the data is tampered with. Therefore, during the data validation, rather than that all the data needs to be acquired, only the data at the mapping position needs to be acquired.

A data size (the number of bits) of the data at the mapping position is equivalent to that of the calculation result. In general, to-be-validated data (such as firmware data) has a large data length (at least in Mbit level), so for a smaller data length of the calculation result obtained by performing calculation for the data segment, the data size of the data that needs to be acquired during data validation is smaller, and efficiency of data validation is higher. Therefore, an algorithm adopted for calculation for the data segment may preferably be a mapping algorithm capable of mapping data with a larger length (such as greater than a first threshold) to data with a smaller length (such as smaller than a second threshold), such as a digest algorithm. The digest algorithm may also be called a data digest algorithm or a message digest algorithm, which refers to an algorithm that converts an input with arbitrary length to generate a fixed length pseudo-random output, such as the SHA256 algorithm. The data length refers to the number of bits (the number of bits) of data. The algorithm adopted for calculation of the data segment may also be other types of algorithms, such as an encryption algorithm or other algorithms that are artificially set.

Taking the to-be-validated data being the firmware data as an example, assume that a size of the firmware data is 10 Mbytes (byte), that is, 80 Mbits. The data size of the data read in a traditional security validation manner is 80 Mbits. Assuming that the firmware data is divided into 2 data segments and the calculation result obtained by performing a hashing operation on each data segment through the SHA256 algorithm is 256 bits, then, in accordance with the solution of the present disclosure, the data size of the data read for security validation is 2*256 bit=512 bit, about 0.0006% of that in a traditional solution, which greatly improves the efficiency of the security validation. Moreover, the size of the firmware is generally tens of Mbytes or even hundreds of Mbytes, and there are multiple firmware in a server. In this case, an efficiency improvement effect is more obvious.

The details involved in the present disclosure will be further described below.

FIG. 2 shows a schematic flowchart of a data validation method according to an embodiment of the present disclosure. The method shown in FIG. 2 may be executed by a data validation apparatus, for example, may be executed by a trusted platform control module (TPCM) for performing a security validation on firmware data.

Referring to FIG. 2, in step S210, at least part of first data acquired from a storage apparatus is divided into at least one data segment.

The first data refers to data in the storage apparatus on which tamper-proofing validation needs to be performed. The at least part of the first data may refer to all of the first data, or some of the first data. As an example, the storage apparatus may be a non-volatile memory (such as a flash memory), and the first data may be firmware data stored in the non-volatile memory.

In step S220, calculation is performed for each of the at least one data segment to obtain at least one calculation result.

Performing the calculation for each of the at least one data segment refers to using an algorithm to change original information data of the data segment to obtain a calculation result different from the data segment. Furthermore, performing the calculation for each of the at least one data segment refers to using an algorithm to perform calculation on (or map) data with a larger length into data with a smaller length.

The calculation performed on the data segment may be called an encryption calculation, the algorithm used in above process may be called an encryption algorithm, and the obtained calculation result may be called an encryption result. It should be noted that the encryption mentioned in the present disclosure emphasizes that in the encryption result, the original data of the data segment gets changed. Whether the encryption result supports decryption, that is, whether the encryption algorithm used supports restoring the encryption result to the data segment, is not required in the present disclosure.

According to the above description of the principle of the data validation method of the present disclosure, it can be known that a digest algorithm may be used for calculation on the data segment to map the data segment with a first number of bits (bit) to data with a second number of bits (bit), where the second number is less than the first number. Taking the digest algorithm being a SHA256 hash algorithm as an example, the SHA256 hash algorithm causes a data segment with any length to be mapped to a calculation result with a length of 256 bits. The data length of the calculation result is short, and the calculation result also is of better randomness.

In step S230, for each of the at least one calculation result, data that conforms to a constraint relationship with the calculation result is searched for from the acquired first data, and a position of the data obtained through the searching in the first data is determined.

Regarding the constraint relationship, reference may be made to the above relevant description, and details will not be repeated here. By searching for the data in the first data that conforms to the constraint relationship with the calculation result, and determining the position of the data obtained through the searching in the first data, the calculation result may be mapped to the first data, that is, the calculation result is stored in the first data.

Each data segment corresponds to one calculation result. For each calculation result, there may be zero, one or more pieces of data conforming to the constraint relationship with the calculation result in the first data. When searching for the data that conforms to the constraint relationship with the calculation result from the acquired first data, if there is no data that conforms to the constraint relationship with the calculation result in the first data, the calculation result may be ignored, that is, the calculation result is not mapped to the first data, that is, there is no mapping position corresponding to the calculation result in the first data. If there are a plurality of data in the first data that conform the constraint relationship with the calculation result, one of the plurality of data may be selected, and the position of the selected data may be used as the mapping position of the calculation result in the first data, or the plurality of data may be selected, and the selected positions of the plurality of data are used as mapping positions of the calculation result in the first data. Therefore, one calculation result may correspond to zero, one or more positions.

When the number of bits of the calculation result is small (such as less than or equal to 8 bits), the probability of finding continuous data that conforms to the constraint relationship with the entire calculation result in the first data is high, and the calculation result may be directly stored in the first data. At this time, the position of the calculation result in the first data is a string of continuous positions.

When the number of bits of the calculation result is larger (such as greater than 8 bits, for example, in a situation that the SHA256 algorithm is adopted, the number of bits of each calculation result is 256 bits), the probability of directly finding the continuous data that conforms to the constraint relationship with the entire calculation result in the first data is small, that is, there is no mapping position corresponding to the entire calculation result in the first data. In order to successfully store (i.e., map) the calculation result into the first data, the present disclosure proposes that a segmentation processing may be performed on the calculation result, and the data conforming to the constraint relationship with each segment may be searched for in the first data.

Specifically, the calculation result may be divided into at least one first data segment, and for each of the at least one first data segment, a second data segment that conforms to the constraint relationship with the first data segment is searched for from the acquired first data, and the position of the second data segment obtained through the searching in the first data is determined. At this time, the mapping position of one calculation result in the first data includes multiple data segment positions, and these multiple data segment positions may be multiple dispersed positions. Each data segment position corresponds to a part of the calculation result (i.e., the first data segment). Thus, the calculation result may be indirectly stored in the first data by dividing the calculation result.

A size (that is, the number of bits) of the first data segment may be set arbitrarily. The less the number of bits for segmenting the calculation result, the greater the probability of finding the segmented data (that is, the first data segment) in the first data, but the more the positions that need to be recorded, that is, the longer an index table used for recording the positions is. Generally, for any binary data with 8 bits or less bits, it may be considered that there is a high probability and it is even certain that the same data as the binary data can be found in the to-be-validated data (such as the firmware data). Therefore, the size of the first data segment may be less than or equal to 8 bits.

In step S240, a correspondence relationship between the position and the calculation result is associatively stored.

As described above, one calculation result may be divided into multiple first data segments, and the mapping position of one calculation result in the first data may include multiple data segment positions, and each data segment position corresponds to one first data segment. Thus, for each calculation result, the correspondence relationship between the data segment position and the first data segment may be associatively stored. The data segment position corresponding to the first data segment refers to the position, in the first data, of the second data segment that conforms to the constraint relationship with the first data segment in the first data, and this position may represent a logical position of data (such as an offset of the data in the first data), rather than a physical storage position of the data.

In summary, each calculation result may correspond to a string of continuous positions, or may correspond to multiple dispersed positions, that is, each position may correspond to the entire calculation result, or may correspond to a part of the calculation result (i.e., the first data segment).

This correspondence relationship between positions and calculation results may be recorded in an index (table). Taking the calculation result including multiple first data segments as an example, after the position of each first data segment in the first data is determined, the correspondence relationship between each first data segment and its position may be recorded in the index table generated for the calculation result.

After the correspondence relationship between the position and the calculation result is associatively stored, when validation of the first data needs to be performed subsequently, rather than that all the first data needs to be acquired from the storage apparatus, only the second data at the said position in the first data needs to be acquired from the storage apparatus according to the stored correspondence relationship between the position and the calculation result. Then, based on the correspondence relationship, it is determined whether the acquired second data and the calculation result corresponding to the said position conform to the constraint relationship. If there is second data that does not conform to the constraint relationship with the calculation result corresponding to the said position, it may be determined that the first data is tampered with.

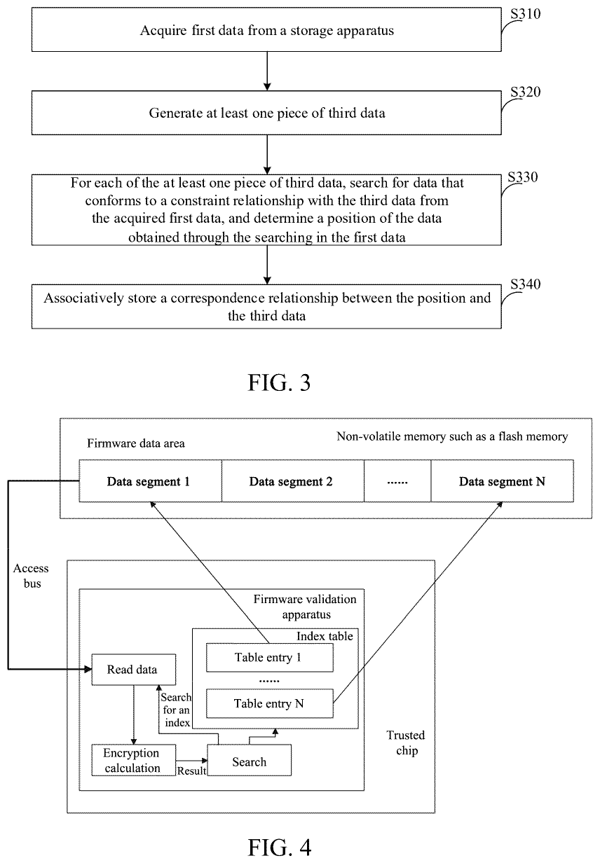

FIG. 3 shows a schematic flowchart of a data validation method according to another embodiment of the present disclosure. The method shown in FIG. 3 may be executed by a data validation apparatus, for example, may be executed by a trusted platform control module (TPCM) for performing a security validation on firmware data.

Referring to FIG. 3, in step S310, first data is acquired from a storage apparatus.

In step S320, at least one piece of third data is generated.

In step S330, for each of the at least one piece of third data, data that conforms to a constraint relationship with the third data is searched for from the acquired first data, and a position of the data obtained through the searching in the first data is determined.

In step S340, a correspondence relationship between the position and the third data is associatively stored.

The difference from the method shown in FIG. 2 is that in this embodiment, one or more third data may be randomly generated by using, for example, a randomized algorithm, that is, generation of the third data may not depend on the first data.

Similar to the validation method shown in FIG. 2, when validation of the first data needs to be performed subsequently, rather than that all the first data needs to be acquired from the storage apparatus, only the second data (i.e., a part of the first data) at the position needs to be acquired from the storage apparatus according to the stored correspondence relationship between the position and the third data. Then, based on the correspondence relationship, it is determined whether the acquired second data and the third data corresponding to the position conform to the constraint relationship. If there is second data that does not conform to the constraint relationship with the third data corresponding to the position, it may be determined that the first data is tampered with.

In order to ensure that the data conforming to the constraint relationship with the third data can be found from the first data, the third data may be divided into multiple third data segments, and for each of the third data segments, a fourth data segment that conforms to the constraint relationship with the third data segment is searched for from the acquired first data, and a data segment position of the fourth data segment obtained through the searching in the first data is determined. Thus, similar to the above-mentioned second data, a mapping position of the third data in the first data may also include multiple data segment positions, and these multiple positions may be dispersed. A size of the third data segment may be set arbitrarily, for example, less than or equal to 8 bits.

### Application Example

The specific implementation process of the present disclosure applied in a firmware validation scenario will be further described below.

An important function of TPCM is a security validation of various firmware in a system to avoid security risks caused by the firmware being tampered with. The firmware in the system may include but not limited to BIOS Firmware, BMC Firmware, OptionROM Firmware, etc. BIOS refers to basic input output system. BMC refers to baseboard management controller. OptionROM refers to option ROM.

Firmware validation is performed after the Firmware is read through SPI and other buses. Every time the system starts, various firmware information needs to be read, which undoubtedly increases a system startup time. Under a premise of ensuring safety, this solution may greatly reduce validation time of the firmware, thereby improving system startup efficiency under the premise of ensuring the safety of an entire system.

A trusted chip (i.e., TPCM) is interconnected with a non-volatile storage such as a flash memory through an access bus. Every time the trusted chip validates a Firmware data area in the non-volatile storage such as the flash memory, all the Firmware data is read for validation. A data size of Firmware is generally tens of Mbytes to hundreds of Mbytes, and access buses for the non-volatile storage such as the flash memory are usually low-speed buses such as SPI and IIC. Thus, firmware security validation increases the entire startup time of the system. In a cloud computing scenario, this is inconsistent with the actual requirement of fast delivery.

In the industry, TPCM is used for firmware validation. All the data of the firmware is completely read during every validation, and it takes a long time. There are multiple firmware in a server, and in this case, a time-consuming problem is particularly obvious.

A firmware security validation system may include a non-volatile memory (such as the flash memory) and a trusted chip. The non-volatile memory is used to store Firmware (BIOS, BMC and other software programs). The trusted chip is used to check whether Firmware data is tampered with.

When the trusted chip performs the validation for the first time, it may read all to-be-validated firmware data from the non-volatile memory through the access bus, and obtain an index indicating the correspondence relationship between the position and the calculation result according to the method shown in above FIG. 2.

Specifically, the trusted chip may read the firmware data from the non-volatile memory through the access bus, divide at least part of the read firmware data into at least one data segment, and perform calculation for each of the at least one data segment to obtain at least one calculation result, and for each of the at least one calculation result, search for data that conforms to a constraint relationship with the calculation result from the read firmware data, and determine a position of the data obtained through the searching in the firmware data, and associatively store a correspondence relationship between the position and the calculation result.

In the subsequent validation, rather than having to read all the firmware data from the non-volatile memory, the trusted chip may read part of the firmware data according to the position recorded in the index to perform the validation.

Specifically, the trusted chip may read the firmware data at the position from the non-volatile memory through the access bus according to the position recorded in the index. The index is used to record the correspondence relationship between the position and the calculation result, the calculation result is a calculation result obtained by performing a calculation on a data segment, and the data segment is obtained by dividing at least part of the firmware data stored in the non-volatile memory. The trusted chip may also determine, based on the correspondence relationship, whether the read firmware data and the calculation result corresponding to the position conform to the constraint relationship. If there is firmware data that does not conform to the constraint relationship with the calculation result corresponding to the position, it is determined that the firmware data stored in the non-volatile memory is tampered with.

FIG. 4 shows a schematic structural diagram of a firmware validation system according to an embodiment of the present disclosure.

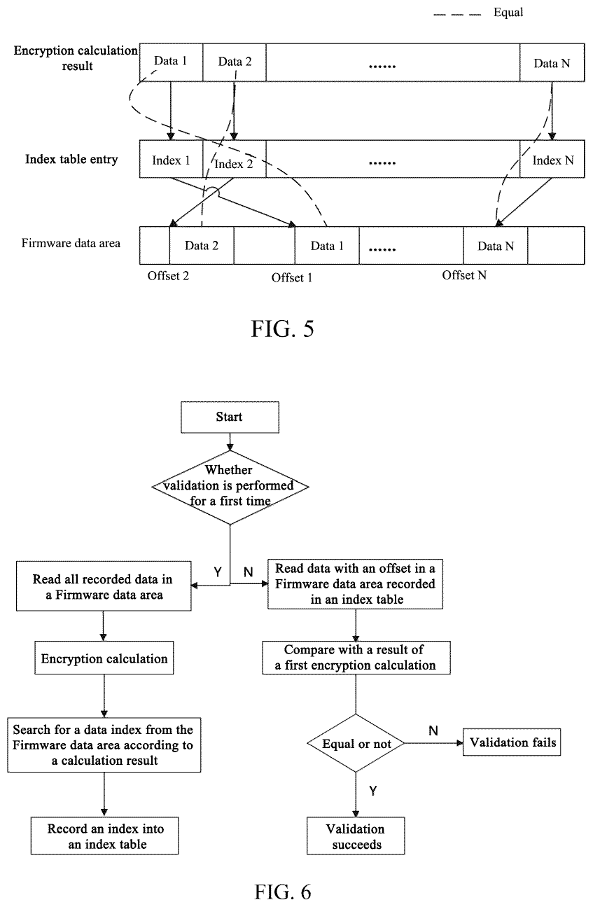

FIG. 5 shows a mapping relationship between an encryption calculation result, an index entry and a Firmware data area.

FIG. 6 shows a schematic flowchart of a trusted validation process of the present disclosure.

Referring to FIG. 4 to FIG. 6, the non-volatile memory such as a flash memory includes a Firmware data area. A trusted chip includes a Firmware validation apparatus, and the Firmware validation apparatus includes a data reading module, an encryption calculation module, a searching module, an index table module, and the like. The non-volatile memory and the trusted chip are connected through an access bus (usually SPI, IIC and other buses).

The trusted chip may read data from the non-volatile storage such as the flash memory by the access bus. When the trusted chip performs Firmware security validation for the first time, it reads all Firmware data.

Afterwards, the read data is divided into several data segments, that is, data segment 1, data segment 2, . . . , data segment N shown in the figure. For each of these several data segments, an encryption calculation is performed. The encryption calculation module sends the calculation result to the searching module. The searching module searches for data of the result from original data stored in the reading module, and records an offset of the data obtained through the searching in the original data, and finally collects all the offsets into the index table module to generate the index table entries.

A hash algorithm (SHA256, etc.) may be adopted for the encryption calculation, so a length of the calculation result is much smaller than a length of the Firmware data area. The index table records an index table of each data segment, as shown in FIG. 4, table entry 1 of the index table records an index of data segment 1, table entry N records an index of data segment N, and so on.

The encryption result of each data segment may be segmented, so the encryption calculation result may contain several data (such as data 1, data 2, . . . , data N), the index table entries contain several indexes (index 1, index 2, . . . , index N), the Firmware data area contains several data (data 1, data 2, . . . , data N). Respective data (data 1, data 2, . . . , data N) in the encryption calculation result is the same as respective data (data 1, data 2, . . . , data N) in the Firmware data area. Thus, the trusted chip indirectly stores the encryption calculation results in the non-volatile storage such as the flash memory without changing the original data in the non-volatile storage such as the flash memory. The index table entries record the offsets of the encryption calculation result in the Firmware data area, that is, the trusted chip may read data 2 in the Firmware data area through index 2 (corresponding to offset 2 in the Firmware data area) in the index table entries, and data 2 in the Firmware data area and data 2 in the encryption calculation result are the same.

Based on this, the trusted chip read all the data only when validation of the Firmware data area is performed for a first time, and index table entries are thus obtained. In subsequent validations, there is no need to read all the data, just read the data at the position indicated by an indexed offset recorded in the index table entries, and compare whether the read data is equal to the encryption calculation result obtained through the first validation. Thus, a size of data to be read is greatly reduced, thereby reducing time consumed by a security validation. Since the encryption calculation results in this solution are random, the indexes in the index table entries are also randomly distributed in the Firmware data area. This randomness ensures that the solution may confirm whether the Firmware data is tampered with.

In this solution, a number of data segments in the Firmware data area may be 1, that is, encryption calculation may be performed for the entire Firmware data area, and then an index table entry may be obtained. The number of data segments in the Firmware data area may also be greater than 1.

In this solution, the offsets recorded in the index table entries of the index table may be concentrated in a certain data segment, or may be dispersed to multiple data segments. For example, index 1 in index table entry 1 may be located in data segment 2 of the Firmware data area, and index 2 in index table entry 1 may be located in data segment 1 of the Firmware data area. For another example, all indexes in index table entry 2 may be located in data segment 2 of the Firmware data area.

Assuming that a length of the Firmware data area is n bits and they are divided into m data segments. The SHA256 encryption algorithm is adopted. A size of data read by a traditional security validation method is n bits, and a size of data read by the security validation method of this solution is m*256 bits.

In general, a size of the firmware is tens of Mbytes. Assuming that a size of the firmware is 10 Mbytes, that is, 80 Mbits. The size of data read by the traditional security validation method is 80 Mbits. In this solution, it is assumed that the Firmware data area is divided into 2 segments, and the size of data read for the security validation is 2*256 bit=512 bit, about 0.0006% of that in a traditional solution, which greatly improves the efficiency of the security validation. However, the size of the firmware is generally tens of Mbytes or even hundreds of Mbytes, and there are multiple firmware in a server. In this case, an efficiency improvement effect is more obvious.

In summary, in this solution, the encryption calculation result is indirectly stored to the Flash data area, reducing the reading of the Flash data and reducing the time consumed by the firmware security validation. Specifically, in this solution, the index table is established during the first firmware security validation, and a mapping of the encryption calculation result to the Flash data is recorded, which is equivalent to indirectly storing the encryption calculation result in the Flash data area; for non-first firmware security validation, only data with the offset recorded in the index table is read, which greatly reduces the size of data to be read; a hash algorithm may be adopted as the encryption algorithm, which has high randomness and a small data length, which ensures reliability of firmware validation security and the read data size.

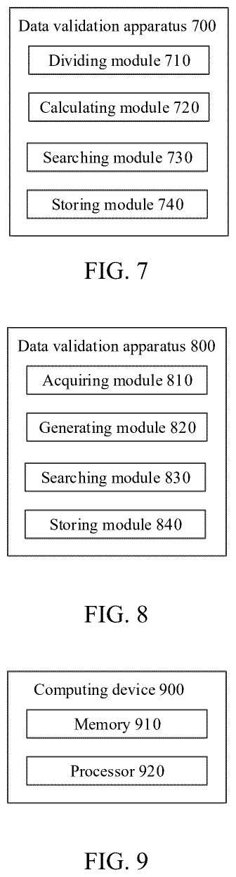

The data validation method of the present disclosure may also be implemented as a data validation apparatus. A functional unit of the data validation apparatus may be implemented by hardware, software or a combination of hardware and software that implement the principle of the present disclosure. Those skilled in the art may understand that the functional unit described in the present disclosure with reference to FIG. 7 and FIG. 8 may be combined or divided into subunits, so as to realize the principle of the above disclosure. Therefore, the description herein may support any possible combination, division, or further limitation of the functional unit described herein.

Below is a brief illustration of the functional unit that the data validation apparatus may have and the operations that may be performed by each functional unit. For the details involved therein, reference may be made to the above relevant description, which will not be repeated here.

FIG. 7 shows a schematic structural diagram of a data validation apparatus according to an embodiment of the present disclosure.

Referring to FIG. 7, a data validation apparatus 700 includes a dividing module 710, a calculating module 720, a searching module 730 and a storing module 740.

The dividing module 710 is configured to divide at least part of first data acquired from a storage apparatus into at least one data segment. The calculating module 720 performs calculation for each of the at least one data segment to obtain at least one calculation result. For each of the at least one calculation result, the searching module 730 searches for data that conforms to a constraint relationship with the calculation result from the acquired first data, and determines a position of the data obtained through the searching in the first data. The storing module 740 associatively stores a correspondence relationship between the position and the calculation result.

The data validation apparatus 700 may further include an acquiring module and a determining module. The acquiring module is configured to acquire second data at the position from the storage apparatus. The determining module is configured to determine, based on the correspondence relationship, whether the acquired second data and the calculation result corresponding to the position conform to the constraint relationship. If there is second data that does not conform to the constraint relationship with the calculation result corresponding to the position, the determining module may determine that the first data is tampered with.

FIG. 8 shows a schematic structural diagram of a data validation apparatus according to another embodiment of the present disclosure.

Referring to FIG. 8, a data validation apparatus 800 includes an acquiring module 810, a generating module 820, a searching module 830 and a storing module 840.

The acquiring module 810 acquires first data from a storage apparatus. The generating module 820 generates at least one piece of third data; for each of the at least one piece of third data, the searching module 830 searches for data that conforms to a constraint relationship with the third data from the acquired first data, and determines a position of the data obtained through the searching in the first data. The storing module 840 associatively stores a correspondence relationship between the position and the third data.

The data validation apparatus 800 may further include a determining module. The acquiring module is configured to acquire second data at the position from the storage apparatus. The determining module is configured to determine, based on the correspondence relationship, whether the acquired second data and the third data corresponding to the position conform to the constraint relationship. If there is second data that does not conform to the constraint relationship with the third data corresponding to the position, the determining module may determine that the first data is tampered with.

FIG. 9 shows a schematic structural diagram of a computing device that may be used to implement the above data validation method according to an embodiment of the present disclosure.

Referring to FIG. 9, a computing device 900 includes a memory 910 and a processor 920.

The processor 920 may be a multi-core processor, or may include multiple processors. In some embodiments, the processor 920 may include a general-purpose main processor and one or more special co-processors, such as a graphics processing unit (GPU), a digital signal processor (DSP), and so on. In some embodiments, the processor 920 may be implemented using a customized circuit, such as application specific integrated circuits (ASIC) or field programmable gate array (FPGA).

The memory 910 may include various types of storage units, such as a system memory, a read only memory (ROM), and a persistent storage apparatus. The ROM may store static data or instructions required by the processor 920 or other modules of a computer. The persistent storage apparatus may be a readable and writable storage apparatus. The persistent storage apparatus may be a non-volatile storage apparatus that does not lose stored instructions and data even if the computer is powered off. In some embodiments, a mass storage apparatus (such as a magnetic or optical disk, a flash memory) is adopted as the persistent storage apparatus. In some other implementations, the persistent storage apparatus may be a removable storage device (such as a floppy disk, an optical drive). A system memory may be a readable and writable storage apparatus or a volatile readable and writable storage apparatus, such as a dynamic random access memory. The system memory may store some or all of the instructions and data that the processor needs during runtime. In addition, the memory 910 may include any combination of computer readable storage media, including various types of semiconductor memory chips (DRAM, SRAM, SDRAM, the flash memory, a programmable read only memory), and magnetic and/or optical disks may also be adopted. In some embodiments, the memory 910 may include a readable and/or writable removable storage device, such as a compact disc (CD), a read only digital versatile disc (e.g., DVD-ROM, dual-layer DVD-ROM), a read only Blu-ray disc, a super density disc, a flash memory card (such as a SD card, a mini SD card, a Micro-SD card, etc.), a magnetic floppy disk, etc. The computer readable storage media do not contain a carrier and a transient electronic signal transmitted by wireless or wire.

Executable codes are stored in the memory 910, and when the executable codes are processed by the processor 920, the processor 920 is caused to execute the above-mentioned data validation method.

The data validation method, the system, the apparatus and the device according to the present disclosure have been described in detail above with reference to the accompanying drawings.

In addition, the method according to the present disclosure may also be implemented as a computer program or computer program product, the computer program or computer program product includes computer program code instructions for executing the above-mentioned steps defined in the above-mentioned method of the present disclosure.

Or, the present disclosure may also be implemented as a non-transitory machine readable storage medium (or a computer readable storage medium, or a machine readable storage medium), having executable codes (or computer programs, or computer instruction codes) stored thereon, when the executable codes (or the computer programs, or the computer instruction codes) are executed by a processor of an electronic device (or a computing device, a server, etc.), the processor is caused to execute the steps of the above method according to the present disclosure.

Those skilled in the art will also aware that the various illustrative logical blocks, modules, circuits, and algorithm steps described in connection with the disclosure herein may be implemented as electronic hardware, computer software, or combinations of both.

A flowchart and a block diagram in the accompany drawings illustrate an architecture, a functionality, and an operation of possible implementations of systems and methods according to various embodiments of the present disclosure. In this regard, each block in the flowchart or the block diagram may represent a module, a part of a program segment, or a part of a code, and the module, the part of the program segment, or the part of the code contains one or more executable instructions for implementing specified logic functions. It should also be noted that, in some alternative implementations, a function noted in the block may occur out of the order noted in the accompany drawings. For example, two continuous blocks may, in fact, be executed in parallel substantially, or they may sometimes be executed in a reverse order, depending upon the functionality involved. It should also be noted that each block of the block diagram and/or flowchart, and a combination of blocks in the block diagram and/or flowchart, may be implemented by a dedicated hardware-based system that performs the specified functions or operations, or may be implemented by a combination of dedicated hardware and computer instructions.

Various embodiments of the present disclosure have been described above, the above illustration is exemplary, not exhaustive, and is not limited to the disclosed embodiments. Many modifications and alterations will be apparent to those of ordinary skilled in the art without departing from the scope and spirit of the illustrated embodiments. The terminology used herein is chosen to best explain the principle of each embodiment, practical application or improvement of technology in the market, or to enable other ordinary skilled in the art to understand various embodiments disclosed herein.

1. A data validation method, comprising:
dividing at least part of first data acquired from a storage apparatus into at least one data segment;
performing calculation for each of the at least one data segment to obtain at least one calculation result;
for each of the at least one calculation result, searching for data that conforms to a constraint relationship with the calculation result from the acquired first data, and determining a position of the data obtained through the searching in the first data;
associatively storing a correspondence relationship between the position and the calculation result.

2. The method according to claim 1, further comprising:
acquiring second data at the position from the storage apparatus;
determining, based on the correspondence relationship, whether the acquired second data and the calculation result corresponding to the position conform to the constraint relationship;
if there is second data that does not conform to the constraint relationship with the calculation result corresponding to the position, determining that the first data is tampered with.

3. The method according to claim 1, wherein the step of performing the calculation for each of the at least one data segment comprises: using a digest algorithm to perform the calculation for each of the at least one data segment, to map the data segment of a first number of bits to data of a second number of bits, wherein the second number is less than the first number.

4. The method according to claim 1, wherein both the data obtained through the searching and the calculation result are binary data, the data obtained through the searching and the calculation result are of a same number of bits, and the constraint relationship is:
a value of any bit of the bits for the data obtained through the searching is equal to a value of a corresponding bit of the bits for the calculation result; or
a value of any bit of the bits for the data obtained through the searching is not equal to a value of a corresponding bit of the bits for the calculation result; or
a part of the binary data for the data obtained through the searching is equal to a corresponding part of the binary data for the calculation result, and a value of a bit of a remaining part of the binary data for the data obtained through the searching is not equal to a value of a corresponding bit of a remaining part of the binary data for the calculation result.

5. The method according to claim 1, wherein,
the storage apparatus is a non-volatile storage apparatus, and the first data is firmware data.

6. The method according to claim 1, wherein,
the step of the performing the calculation for each of the at least one data segment comprises: using a hash algorithm to perform the calculation for each of the at least one data segment, and/or
the step of the for each of the at least one calculation result, searching for data that conforms to the constraint relationship with the calculation result from the acquired first data, and determining the position of the data obtained through the searching in the first data comprises: dividing the calculation result into at least one first data segment; for each of the at least one first data segment, searching for a second data segment that conforms to the constraint relationship with the first data segment from the acquired first data, and determining a data segment position of the second data segment obtained through the searching in the first data,
the step of the associatively storing the correspondence relationship between the position and the calculation result comprises: associatively storing a correspondence relationship between the data segment position and the first data segment.

7. A data validation method, comprising:
for a position recorded in an index, acquiring second data at the position from a storage apparatus, wherein the index is used to record a correspondence relationship between the position and a calculation result, the calculation result is a calculation result obtained by performing calculation for a data segment, and the data segment is obtained by dividing at least part of first data stored in the storage apparatus;
determining, based on the correspondence relationship, whether the acquired second data and the calculation result corresponding to the position conform to a constraint relationship;
if there is second data that does not conform to the constraint relationship with the calculation result corresponding to the position, determining that the first data is tampered with.

8-9. (canceled)

10. A firmware security validation system, comprising:
a non-volatile memory, configured to store firmware data;
a trusted chip, configured to: read the firmware data from the non-volatile memory through an access bus; divide at least part of the read firmware data into at least one data segment; perform calculation for each of the at least one data segment to obtain at least one calculation result; for each of the at least one calculation result, search for data that conforms to a constraint relationship with the calculation result from the read firmware data, and determine a position of the data obtained through the searching in the firmware data; and associatively store a correspondence relationship between the position and the calculation result.

11. (canceled)

12. A computing device, comprising:
a processor; and
a memory having executable codes stored thereon, wherein when the executable codes are executed by the processor, the processor is caused to execute the method according to claim 1.

13. (canceled)

14. A non-transitory machine readable storage medium, having executable codes stored thereon, wherein when the executable codes are executed by a processor of an electronic device, the processor is caused to execute the method according to claim 1.

15. The system according to claim 10, wherein the trusted chip is further configured to:
acquire second data at the position from the storage apparatus;
determine, based on the correspondence relationship, whether the acquired second data and the calculation result corresponding to the position conform to the constraint relationship;
if there is second data that does not conform to the constraint relationship with the calculation result corresponding to the position, determine that the firmware data is tampered with.

16. The system according to claim 10, wherein the trusted chip is further configured to:
use a digest algorithm to perform the calculation for each of the at least one data segment, to map the data segment of a first number of bits to data of a second number of bits, wherein the second number is less than the first number.

17. The system according to claim 10, wherein both the data obtained through the searching and the calculation result are binary data, the data obtained through the searching and the calculation result are of a same number of bits, and the constraint relationship is:
a value of any bit of the bits for the data obtained through the searching is equal to a value of a corresponding bit of the bits for the calculation result; or
a value of any bit of the bits for the data obtained through the searching is not equal to a value of a corresponding bit of the bits for the calculation result; or
a part of the binary data for the data obtained through the searching is equal to a corresponding part of the binary data for the calculation result, and a value of a bit of a remaining part of the binary data for the data obtained through the searching is not equal to a value of a corresponding bit of a remaining part of the binary data for the calculation result.

18. The system according to claim 10, wherein the trusted chip is further configured to:
use a hash algorithm to perform the calculation for each of the at least one data segment, and/or
divide the calculation result into at least one firmware data segment; for each of the at least one firmware data segment, search for a second data segment that conforms to the constraint relationship with the firmware data segment from the acquired firmware data, and determine a data segment position of the second data segment obtained through the searching in the firmware data,
associatively store a correspondence relationship between the data segment position and the firmware data segment.

19. A firmware security validation system, comprising:
a non-volatile memory, configured to store firmware data;
a trusted chip, configured to execute the method according to claim 7.

20. A computing device, comprising:
a processor; and
a memory having executable codes stored thereon, wherein when the executable codes are executed by the processor, the processor is caused to execute the method according to claim 7.

21. A non-transitory machine readable storage medium, having executable codes stored thereon, wherein when the executable codes are executed by a processor of an electronic device, the processor is caused to execute the method according to claim 7.
